(19) United States
(12) Patent Application Publication
(10) Pub. No.: US 2019/0360580 A1
(43) Pub. Date: Nov. 28, 2019

(54) GEAR-BOX ARRANGEMENTS

(71) Applicants: Siu Yun Poon, Nottingham (GB); Christopher James Blockley, Nottingham (GB); David John Scott, Nottingham (GB); Paul James Gibbs, Nottingham (GB); Michael Cosmo Barnes, Doncaster (GB)

(72) Inventors: Siu Yun Poon, Nottingham (GB); Christopher James Blockley, Nottingham (GB); David John Scott, Nottingham (GB); Paul James Gibbs, Nottingham (GB); Michael Cosmo Barnes, Doncaster (GB)

(21) Appl. No.: 16/452,267

(22) Filed: Jun. 25, 2019

Related U.S. Application Data
(63) Continuation-in-part of application No. 13/516,890, filed on Jan. 25, 2013, now abandoned.

(30) Foreign Application Priority Data
Dec. 18, 2009 (GB) 0922345.4

(51) Int. Cl. F16H 57/08; F16H 1/46; F03D 80/70; F16C 19/38

(52) U.S. Cl. CPC F16H 57/08; F16H 1/46; F03D 80/70; F03D 15/00; F16H 2057/085; F05B 2240/54; F16C 19/385

(57) ABSTRACT

A wind turbine gear box arrangement having one or more bearings located in a single region along the longitudinal axis and arranged to provide support between an input shaft and a non-rotating support component. The one or more bearings are arranged to at least partially restrict non-rotational movement between the input shaft and the non-rotating support component. A portion along the longitudinal axis between said input shaft and the non-rotating support component is bearingless outside the single region.

### FIELD OF THE INVENTION

Embodiments of the present invention relate to gear box arrangements. In particular, they relate to gear box arrangements in a wind turbine.

### BACKGROUND TO THE INVENTION

Wind turbines are devices for converting wind power into electrical power and usually include a rotor, a gear box and a generator. In operation, wind causes the rotor to rotate and to provide a high torque, relatively low frequency input to the gear box. The gear box converts the high torque input from the rotor to a low torque, relatively high frequency output. The generator is connected to the output of the gear box and converts the rotational movement into electrical power.

Wind turbines having a relatively high output power (e.g. above 1 MW) are usually large (e.g. the rotor may have a diameter of over 100 meters). In order to convert the high torque input from the rotor, the gear box may also have to be relatively large to accommodate the gear arrangements required. However, such gear boxes may be relatively expensive to manufacture (e.g. due to the use of large bearings) and may be relatively heavy and consequently difficult to set up.

It would therefore be desirable to provide alternative gear box arrangements.

### BRIEF DESCRIPTION OF VARIOUS EMBODIMENTS OF THE INVENTION

According to various, but not necessarily all, embodiments of the invention there is provided a wind turbine gear box arrangement comprising: an input shaft arranged to rotate about a longitudinal axis; a non-rotating support component arranged to support the input shaft; one or more bearings located in a single region along the longitudinal axis and arranged to provide support between the input shaft and the non-rotating support component, wherein the one or more bearings are arranged to at least partially restrict non-rotational movement between the input shaft and the non-rotating support component, the wind turbine gearbox arrangement including no further bearings between the input shaft and the non-rotating support component in other regions along the longitudinal axis.

The one or more bearings may be arranged to restrict relative radial movement between the input shaft and the non-rotating support component.

The one or more bearings may be arranged to restrict relative axial movement between the input shaft and the non-rotating component.

The one or more bearings may be arranged to restrict relative tilt movement between the input shaft and the non-rotating component.

The non-rotating support component may be at least partially positioned within the input shaft.

The one or more bearings may comprise a double row tapered roller bearing.

The input shaft may be arranged to define an outer surface of a wind turbine gear box.

According to various, but not necessarily all, embodiments of the invention there is provided a wind turbine comprising a wind turbine gear box arrangement as described in any of the preceding paragraphs.

According to various, but not necessarily all, embodiments of the invention there is provided a module for a wind turbine gear box, comprising: a housing connectable to, and detachable from, the wind turbine gear box; an output shaft mounted within the housing and including a gear portion, the gear portion being engageable with a gear of the wind turbine gear box.

The module may further comprise one or more bearings arranged to provide support between the housing and the output shaft.

The one or more bearings may include a back to back bearing arrangement having an O configuration.

The module may further comprise a plurality of fasteners for connecting the housing of the module to the wind turbine gear box.

According to various, but not necessarily all, embodiments of the invention there is provided a wind turbine gear box comprising a module as described in any of the preceding paragraphs.

According to various, but not necessarily all, embodiments of the invention there is provided a wind turbine comprising a module as described in any of the preceding paragraphs.

According to various, but not necessarily all, embodiments of the invention there is provided a method comprising: assembling a module as described in any of the preceding paragraphs; and connecting the module to a wind turbine gear box.

The step of assembling the module may be performed at a factory and the module is connected to the wind turbine gear box in a nacelle of a wind turbine.

The method may further comprise removing the module from the wind turbine gear box.

The module may include a first plurality of gear teeth and a further module as described in any of the preceding paragraphs includes a second plurality of gear teeth, different in number to the first plurality of gear teeth, and the method may further comprise detaching the module from the wind turbine gear box and connecting the further module to the wind turbine gear box.

According to various, but not necessarily all, embodiments of the invention there is provided a shaft for a wind turbine gear box comprising: a first conduit for receiving one or more electrical cables; a second conduit, different to the first conduit, for receiving a pressurized lubricant for distribution to one or more components of the wind turbine gear box.

The first conduit may include a first tube and the second conduit may include a second tube, the first tube being positioned within the second tube.

The first conduit may include a first tube and the second conduit may include a second tube, the shaft may further comprise an outer tube, wherein the first tube and the second tube are positioned within the outer tube.

The shaft may be arranged to rotate about a longitudinal axis and may further comprise a first rotary fluid coupling for receiving pressurized lubricant from a non-rotating lubricant reservoir.

A pump may be connected to the second conduit via the first rotary fluid coupling, and may be arranged to provide pressurized lubricant to the second conduit.

The shaft may be arranged to rotate about a longitudinal axis and may further comprise a second rotary fluid coupling connected to one or more components of the wind turbine gear box for providing pressurized lubricant to the one or more components of the wind turbine gear box.

According to various, but not necessarily all, embodiments of the invention there is provided a wind turbine gear box comprising a shaft as described in any of the preceding paragraphs.

According to various, but not necessarily all, embodiments of the invention there is provided a wind turbine comprising a shaft as described in any of the preceding paragraphs.

According to various, but not necessarily all, embodiments of the invention there is provided a gear arrangement comprising: a first gear arranged to rotate about a first longitudinal axis and including a first plurality of gear teeth, and a first portion including a first surface; a second gear arranged to rotate about a second longitudinal axis and including a second plurality of gear teeth, and a second portion including a second surface; wherein the first surface and the second surface are arranged to abut one another and restrict relative non-rotational movement of the first gear and the second gear.

The first surface and the second surface may restrict relative radial movement between the first gear and the second gear when they abut one another.

The first surface and the second surface may restrict relative axial movement between the first gear and the second gear when they abut one another.

The first portion may include a third surface and the second portion may include a fourth surface, the third surface and fourth surface may restrict relative axial movement between the first gear and the second gear when they abut one another.

The first portion may include a third surface and the second portion may include a fourth surface, the third surface and fourth surface may restrict relative radial movement between the first gear and the second gear when they abut one another.

The first portion may be positioned adjacent the first plurality of gear teeth and the second portion may be positioned adjacent the second plurality of gear teeth.

The first gear may be a ring gear of a planetary gear stage and the second gear may be a planet gear of the planetary gear stage.

The first gear may be a sun gear of a planetary gear stage and the second gear may be a planet gear of the planetary gear stage.

According to various, but not necessarily all, embodiments of the invention there is provided a wind turbine gear box comprising a gear arrangement as described in any of the preceding paragraphs.

According to various, but not necessarily all, embodiments of the invention there is provided a wind turbine comprising a gear arrangement as described in any of the preceding paragraphs.

According to various, but not necessarily all, embodiments of the invention there is provided a wind turbine arrangement comprising: a nacelle; a gear box having a longitudinal axis and a first outer surface arranged to rotate about the longitudinal axis; wherein the wind turbine arrangement includes no gear box housing between the first outer surface of the gear box and the nacelle.

The gear box may comprise an input shaft that defines at least a portion of the first outer surface of the gear box.

The gear box may further comprise a non-rotating support component arranged to connect to the nacelle and defines at least a portion of a second outer surface of the gear box.

The gear box may include one or more bearings for providing support between the non-rotating support component and the input shaft.

According to various, but not necessarily all, embodiments of the invention there is provided a wind turbine comprising a wind turbine arrangement as described in any of the preceding paragraphs.

According to various, but not necessarily all, embodiments of the invention there is provided a wind turbine gear box comprising one or more of: a wind turbine gear box arrangement as described in any of the preceding paragraphs; a module as described in any of the preceding paragraphs; a shaft as described in any of the preceding paragraphs; a gear arrangement as described in any of the preceding paragraphs.

### BRIEF DESCRIPTION OF THE DRAWINGS

For a better understanding of various examples of embodiments of the present invention reference will now be made by way of example only to the accompanying drawings in which:

FIG. 1 illustrates a schematic diagram of a wind turbine according to various embodiments of the invention;

FIG. 2 illustrates a schematic diagram of a wind turbine gear box according to various embodiments of the invention;

FIG. 3 illustrates a schematic cross sectional diagram of a wind turbine gear box according to various embodiments of the invention;

FIG. 4A illustrates a schematic cross sectional diagram of a first bearing arrangement according to various embodiments of the invention;

FIG. 4B illustrates a schematic cross sectional diagram of a second bearing arrangement according to various embodiments of the invention;

FIG. 5 illustrates a schematic cross sectional diagram of a gear arrangement according to various embodiments of the invention;

FIG. 6 illustrates a schematic cross sectional diagram of another gear arrangement according to various embodiments of the invention;

FIG. 7 illustrates a schematic cross sectional diagram of the gear arrangements illustrated in FIGS. 5 and 6;

FIG. 8 illustrates a perspective diagram of a shaft according to various embodiments of the invention;

FIG. 9 illustrates a perspective diagram of another shaft according to various embodiments of the invention;

FIGS. 10A, 10B and 10C illustrate an exploded perspective view of a module for a wind turbine gear box according to various embodiments of the invention;

FIG. 11 illustrates a perspective view of a module according to various embodiments of the invention;

FIG. 12 illustrates a perspective view of a wind turbine gear box and a module according to various embodiments of the invention;

FIG. 13A illustrates a cross sectional side view of a module according to various embodiments of the invention;

FIG. 13B illustrates a cross sectional front view of the module illustrated in FIG. 13A; and

FIG. 14 illustrates a method of assembling, connecting and detaching a module according to various embodiments of the invention.

### DETAILED DESCRIPTION OF VARIOUS EMBODIMENTS OF THE INVENTION

In the following description, the wording ‘connect’ and ‘couple’ and their derivatives mean operationally connected/coupled. It should be appreciated that any number or combination of intervening components can exist (including no intervening components).

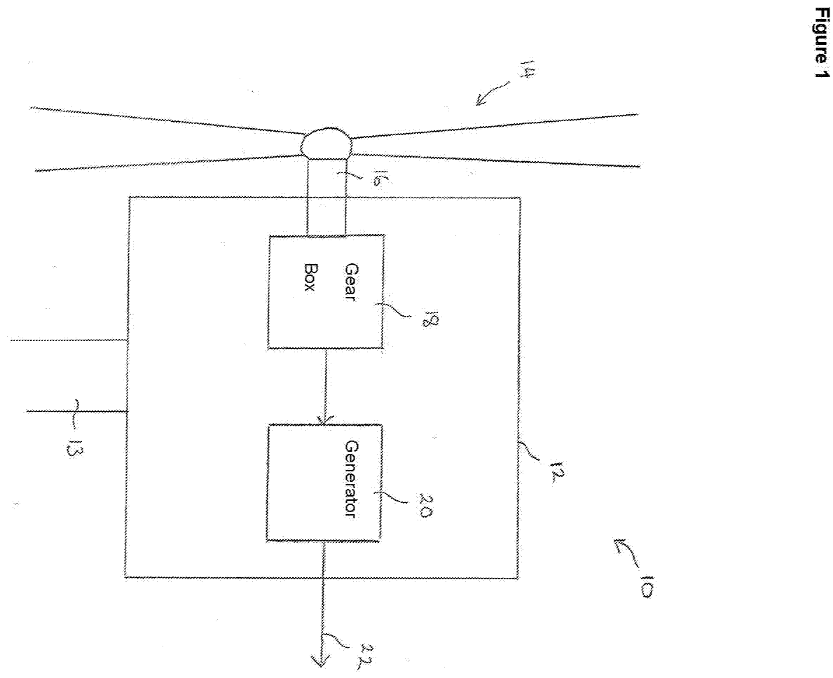

FIG. 1 illustrates a schematic diagram of a wind turbine 10 according to various embodiments of the invention. The wind turbine 10 includes a nacelle 12 (which may also be referred to as a turbine housing), a support post 13, a rotor 14, a rotor shaft 16, a gear box 18 and a generator 20. The wind turbine 10 is arranged to convert wind energy to electrical energy and may have an output power 22 of approximately five megawatts for example. The wind turbine 10 may be installed off-shore or may be installed inland.

The nacelle 12 houses the gear box 18 and the generator 20 and protects them from environmental damage (e.g. caused by rain, snow etc). The support post 13 is connected to the nacelle 12 and to the earth (or to an anchored floating platform when located off-shore).

The rotor 14 is supported by the nacelle 12 and is arranged to rotate in response to the movement of air (wind) past the wind turbine 10. The gear box 18 is connected to the rotor 14 via the rotor shaft 16 and is connected to the nacelle 12. The gear box 18 is arranged to convert the relatively low angular frequency, high torque input from the rotor 14 to a relatively high angular frequency, low torque output. The generator 20 is mounted within the nacelle 12 and is configured to receive the output from the gear box 18 and convert the rotational movement into electrical energy 22.

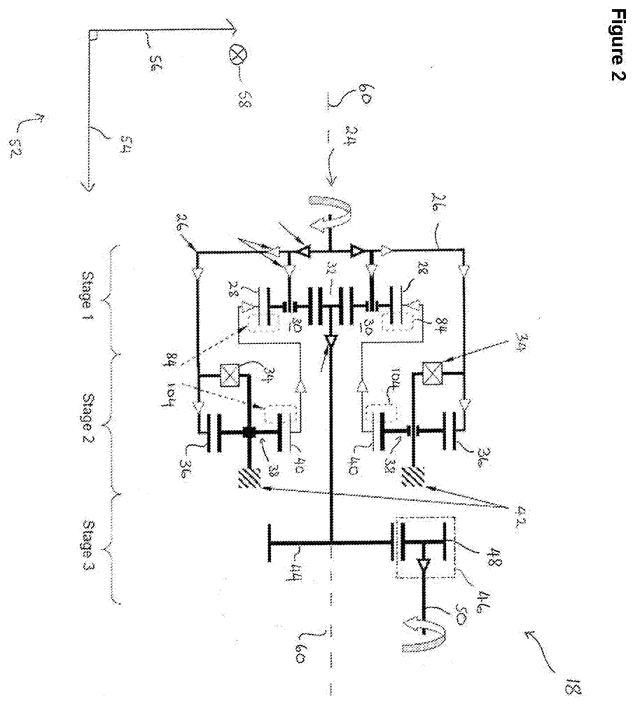

FIG. 2 illustrates a schematic cross sectional diagram of a wind turbine gear box 18 according to various embodiments of the invention. The gear box 18 includes a first stage, a second stage and a third stage. The first stage of the gear box 18 includes an input shaft 24 comprising a planet carrier part 26 connected to the input shaft. The input shaft 24, including the first stage planet carrier 26, is configured to rotate about a longitudinal axis 60. The first stage of the gear box 18 further comprises a ring gear 28, a plurality of planet gears 30, a sun gear 32 and a bearing arrangement 34. The second stage of the gear box 18 includes a ring gear 36, a plurality of planet gears 38, a sun gear 40 and a planet carrier 42 including a non-rotating support component torsionally connected to a fixed or ground point on the wind turbine, such as the nacelle. The third stage of the gear box 18 includes a first output gear 44, a module 46 including a second output gear 48 and an output shaft 50. The arrows illustrated in FIG. 2 represent the flow of torque/power through the gear box 18.

FIG. 2 also illustrates a cylindrical co-ordinate system 52 that includes a longitudinal axis 54 (which may also be referred to as an axial axis), a radial axis 56 and an angular axis 58 (which may also be referred to as the azimuth). The gear box 18 defines a longitudinal axis 60 that extends through the centre of the gear box 18 and is parallel to the longitudinal axis 54 of the cylindrical co-ordinate system 52.

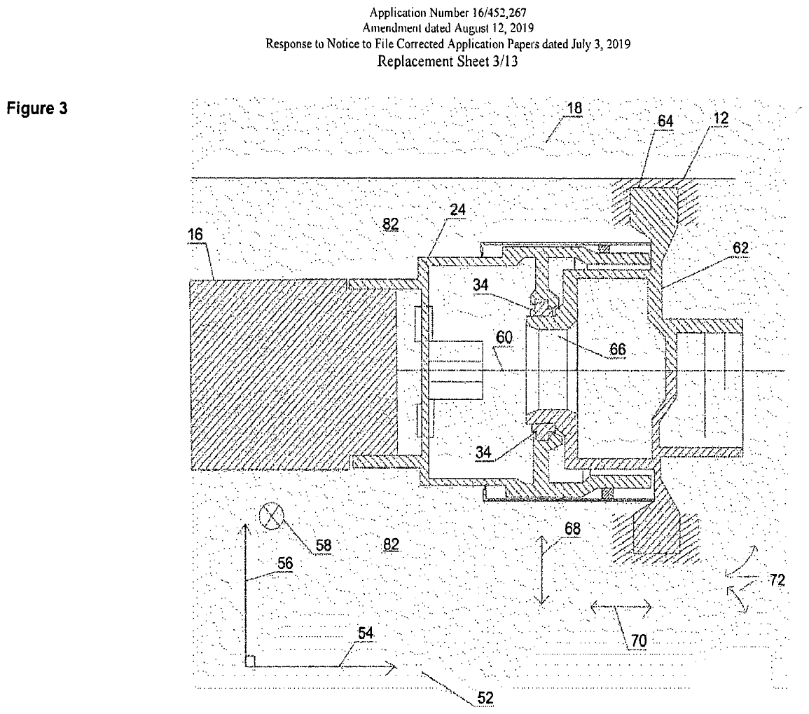

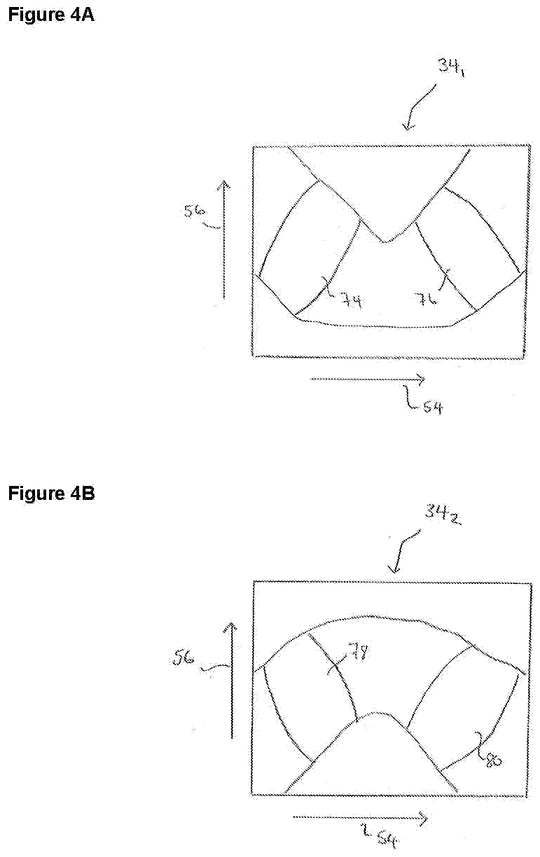

The input shaft 24 is connected to the rotor shaft 16 (illustrated in FIG. 1) and is arranged to rotate about the longitudinal axis 60 in a direction substantially parallel with the angular axis 58. The input shaft 24 supports the non-rotating support component and the bearing arrangement 34. This feature will be described in more detail with reference to FIGS. 3, 4A and 4B.

The plurality of first stage planet gears 30 are positioned within, and engage the first stage ring gear 28. The first stage planet carrier 26 is connected to the plurality of first stage planet gears 30 and is arranged to rotate the plurality of first stage planet gears 30 about the longitudinal axis 60 within the ring gear 28 in a direction substantially parallel with the angular axis 58. The first stage sun gear 32 is positioned within, and engages the plurality of first stage planet gears 30. The rotation of the plurality of first stage planet gears 30 causes the sun gear 32 to rotate about the longitudinal axis 60 in a direction substantially parallel with the angular axis 58.

The second stage ring gear 36 is connected to the first stage planet carrier 26 and is arranged to rotate about the longitudinal axis 60 in a direction substantially parallel with the angular axis 58. The plurality of second stage planet gears 38 are positioned within the second stage ring gear 36 and are connected to the second stage planet carrier 42. The second stage planet carrier 42 is a non-rotational component and is torsionally coupled to the nacelle 12 of the wind turbine 10. Consequently, the plurality of second stage planet gears 38 do not rotate about the longitudinal axis 60. However, the plurality of second stage planet gears 38 each define a longitudinal axis and are arranged to rotate about their own longitudinal axis. The second stage sun gear 40 is positioned within, and engages the plurality of second stage planet gears 38 and is arranged to rotate about the longitudinal axis 60 in a direction substantially parallel with the angular axis 58. The second stage sun gear 40 is connected to the first stage ring gear 28 and drives the first stage ring gear 28 to rotate about the longitudinal axis 60.

The third stage first output gear 44 is connected to the first stage sun gear 32 and is driven by the first stage sun gear 32. The third stage first output gear 44 is arranged to rotate about the longitudinal axis 60 in a direction substantially parallel with the angular axis 58. The third stage first output gear 44 is arranged to engage the third stage second output gear 48 and drive the second output gear 48 to rotate about the longitudinal axis of the second output gear 48 in a direction substantially parallel with the angular axis 58. The second output gear 48 is connected to the output shaft 50 and drives the output shaft 50 to rotate about the longitudinal axis of the output shaft 50 in a direction substantially parallel with the angular axis 58. The output shaft 50 provides an input to the generator 20.

In operation, wind causes the rotor 14 and the rotor shaft 16 to rotate about the longitudinal axis 60. The rotation of the rotor shaft 16 causes the input shaft 24 (including the first stage planet carrier 26) to rotate and the input shaft 24 receives substantially all the torque/power from the rotor shaft 16. The torque is then divided at the first stage planet carrier 26 into a first path and a second path.

In the first path, the torque is transferred from the first stage planet carrier 26 to the first stage planet gears 30 and then to the first stage sun gear 32. In the second path, the torque is transferred from the first stage planet carrier 26 to the second stage planet gears 38 via the second stage ring gear 36. The torque is then transferred from the second stage planet gears 38 to the second stage sun gear 40 which subsequently transfers the torque to the first stage ring gear 28. The first stage ring gear 28 transfers the torque to the first stage sun gear 32 via the first stage planet gears 30.

It should be understood from the preceding paragraphs that the torque is split at the first stage planet carrier 26 and the torque from the first path and the torque from the second path are combined at the first stage sun gear 32.

The first stage sun gear 32 then transfers the torque to the output shaft 50 via the third stage first output gear 44 and the third stage second output gear 48.

FIG. 3 illustrates a further schematic cross sectional diagram of the wind turbine gear box 18 of FIG. 1 and the cylindrical coordinate system 52. In FIG. 3, the non-rotating support component and the input shaft 24 are illustrated in more detail and the non-rotating support component is denoted by the reference numeral 62.

The body of the non-rotating support component 62 has a generally cylindrical shape and includes a first portion 64 and a second portion 66. The first portion 64 extends radially outwards from the body of the non-rotating support component 62 and is torsionally connected to the nacelle 12 (e.g. by a flexible mounting system). The second portion 66 has a smaller diameter than the input shaft 24 and is positioned at least partially within the input shaft 24.

A sealing arrangement may be provided between the non-rotating support component 62 and the input shaft 24 to prevent lubricant (oil for example) from leaking out between the non-rotating support component 62 and the input shaft 24.

The bearing arrangement 34 is positioned between the second portion 66 and the input shaft 24 in a single region along the longitudinal axis 60. The bearing arrangement 34 may include one or more bearings that are positioned in the single region and may have an ‘O’ configuration. It should be appreciated from FIG. 3 that the wind turbine gear box 18 includes no additional bearings or bearing arrangements between the non-rotating support component 62 and the input shaft 24 at other positions or regions along the longitudinal axis 60.

The bearing arrangement 34 is arranged to at least partially restrict non-rotational movement between the input shaft 24 and the non-rotating support component 62. The bearing arrangement 34 may be arranged to restrict relative radial movement (indicated by the arrow 68), and/or relative axial movement (indicated by the arrow 70), and/or relative tilt movement (that is, movement that includes a radial and an axial component as indicated by arrows 72) between the input shaft 24 and the non-rotating support component 62.

The bearing arrangement 34 may comprise any suitable bearings that are able to restrict relative movement between the input shaft 24 and the non-rotating support component 62 as described above. The bearing arrangement 34 may include a double row tapered roller bearing for example.

FIG. 4A illustrates a schematic cross sectional diagram of a first bearing arrangement 34₁ according to various embodiments the present invention. The first bearing arrangement 34₁ is a double row tapered roller bearing having a first bearing row 74 and a second bearing row 76. The first bearing row 74 and the second bearing row 76 are oriented so that they converge as they extend in a positive radial direction 56. It should be appreciated that the orientation of the first row 74 and the second row 76 includes a radial component and an axial component.

FIG. 4B illustrates a schematic cross sectional diagram of a second bearing arrangement 34₂ according to various embodiments the present invention. The second bearing arrangement 34₂ is also a double row tapered roller bearing having a first bearing row 78 and a second bearing row 80. The first bearing row 78 and the second bearing row 80 are oriented so that they diverge as they extend in a positive radial direction 56. It should be appreciated that the orientation of the first row 78 and the second row 80 includes a radial component and an axial component.

The first and second bearing arrangements 34₁ and 34₂ provide an advantage in that they are able to restrict both radial and axial movement due to the orientation of the bearing rows 74, 76, 78, 80. Consequently, the first and second bearing arrangements 34₁ and 34₂ may both be able to provide support between the input shaft 24 and the non-rotating support component 62 and prevent them from moving relative to one another in the radial 68, axial 70 and tilt 72 directions.

Embodiments of the present invention provide several advantages. One such advantage is that since a single bearing arrangement may be used between the input shaft 24 and the non-rotating support component 62, the weight of the gear box 18 may be reduced. Furthermore, since bearings are relatively expensive components, the above described arrangement may reduce the cost of the gear box.

As illustrated in FIG. 3, the wind turbine gear box 18 does not include a gear box housing between the input shaft 24 and the nacelle 12 (the location of which is indicated generally by reference numeral 82). As the input shaft 24 supports the non-rotating component 62 via the bearing arrangement 34, the gear box 18 does not require any further supporting structure between the input shaft 24 and the non-rotating component 62. This may advantageously reduce the weight and diameter of the gear box 18 and may also reduce the cost of the gear box 18 (as less material such as metal is used to manufacture the gear box 18).

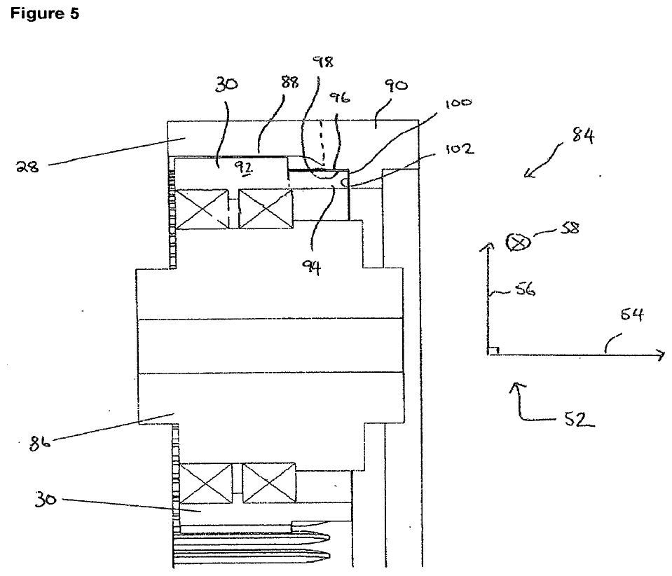

FIG. 5 illustrates a schematic cross sectional diagram of a gear arrangement 84 according to various embodiments of the invention. FIG. 5 also illustrates the cylindrical co-ordinate system 52. The gear arrangement 84 is also illustrated in FIG. 2 and is indicated by a dotted box.

The gear arrangement 84 includes the first stage ring gear 28 and one of the plurality of first stage planet gears 30 (including a planet pin 86). The ring gear 28 includes a first plurality of gear teeth 88 and a first portion 90 that is positioned adjacent the first plurality of gear teeth 88. The planet gear 30 includes a second plurality of gear teeth 92 and a second portion 94 that is positioned adjacent the second plurality of gear teeth 92. It should be appreciated that one or more of the first stage planet gears 30 may include a second portion 94 and the described embodiment only mentions one planet gear 30 to maintain the clarity of the example.

The first portion 90 of the ring gear 28 includes a first surface 96 that is substantially parallel to the longitudinal axis 54. The second portion 94 of the planet gear 30 includes a second surface 98 that is also substantially parallel to the longitudinal axis 54. In operation, the ring gear 28 and the planet gear 30 are arranged to abut one another and restrict relative radial movement between the ring gear 28 and the second gear 30. There may be some clearance between the first and second surfaces such that the abutment only occurs under certain conditions of input load. This may provide an advantage in that the abutment of the first and second surfaces 96, 98 may prevent the first and second pluralities of gear teeth 88, 92 from moving to an arrangement where they may damage one another.

The first portion 90 of the ring gear 28 includes a third surface 100 that is substantially parallel to the radial axis 56. The second portion 94 of the planet gear 30 includes a fourth surface 102 that is also substantially parallel to the radial axis 56. In operation, the ring gear 28 and the planet gear 30 are arranged to abut one another and restrict relative axial movement between the ring gear 28 and the planet gear 30. There may be some clearance between the third and fourth surfaces such that the abutment only occurs under certain conditions of input load. This may provide an advantage in that the abutment of the third and fourth surfaces 100, 102 may prevent the ring gear 28 and the planet gear 30 from moving axially relative to one another (e.g. when the gear box 18 is tilted).

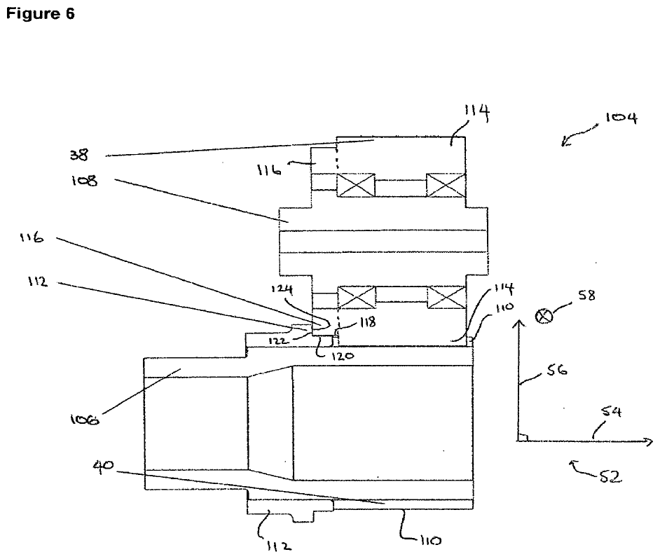

FIG. 6 illustrates a schematic cross sectional diagram of another gear arrangement 104 according to various embodiments of the invention. FIG. 6 also illustrates the cylindrical co-ordinate system 52. The gear arrangement 104 is also illustrated in FIG. 2 and is indicated by a dotted box.

The gear arrangement 104 includes the second stage sun gear 40 (including a rotatable sun shaft 106) and one of the plurality of second stage planet gears 38 (including a non-rotatable planet pin 108). The sun gear 40 includes a first plurality of gear teeth 110 and a first portion 112 that is positioned adjacent the first plurality of gear teeth 110. The planet gear 38 includes a second plurality of gear teeth 114 and a second portion 116 that is positioned adjacent the second plurality of gear teeth 114. It should be appreciated that one or more of the second stage planet gears 38 may include a second portion 116 and the described embodiment only mentions one planet gear 38 to maintain the clarity of the example.

The first portion 112 of the sun gear 40 includes a first surface 118 that is substantially parallel to the longitudinal axis 54. The second portion 116 of the planet gear 38 includes a second surface 120 that is also substantially parallel to the longitudinal axis 54. In operation, the sun gear 40 and the planet gear 38 are arranged to abut one another and restrict relative radial movement between the sun gear 40 and the planet gear 38. There may be some clearance between the first and second surfaces such that the abutment only occurs under certain conditions of input load. This may provide an advantage in that the abutment of the first and second surfaces 118, 120 may prevent the first and second pluralities of gear teeth 110, 114 from moving to an arrangement where they may damage one another.

The first portion 112 of the sun gear 40 includes a third surface 122 that is substantially parallel to the radial axis 56. The second portion 116 of the planet gear 38 includes a fourth surface 124 that is also substantially parallel to the radial axis 56. In operation, the sun gear 40 and the planet gear 38 are arranged to abut one another and restrict relative axial movement between the sun gear 40 and the planet gear 38. There may be some clearance between the third and fourth surfaces such that the abutment only occurs under certain conditions of input load. This may provide an advantage in that the abutment of the third and fourth surfaces 122, 124 may prevent the sun gear 40 and the planet gear 38 from moving axially relative to one another (e.g. when the gear box 18 is tilted).

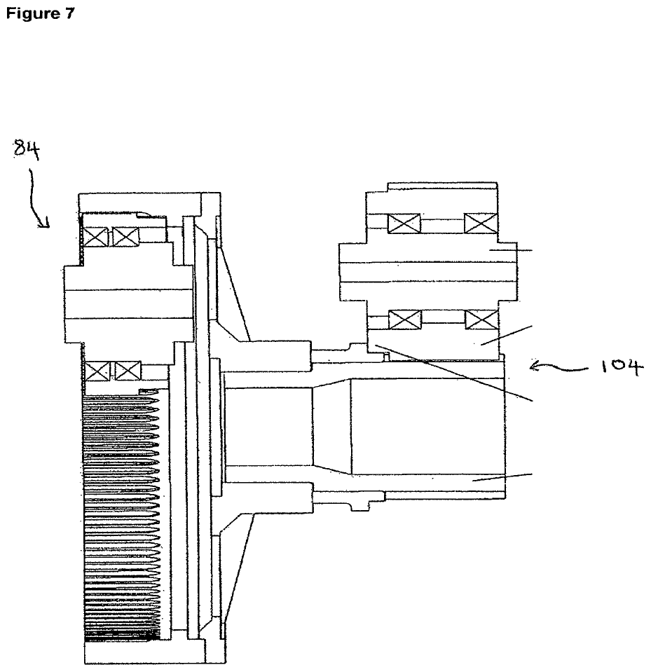

FIG. 7 illustrates a schematic cross sectional diagram of the gear arrangement 84 and the gear arrangement 104 coupled together.

The gear arrangements 84, 104 provide an advantage in that they may enable the gears to support one another on the first, second, third and fourth surfaces. Consequently, the gear arrangements 84, 104 may not require support bearings to support the gears. This may reduce the weight and cost of the gear arrangements 84, 104 and may also reduce the time required to assemble the gear box 18.

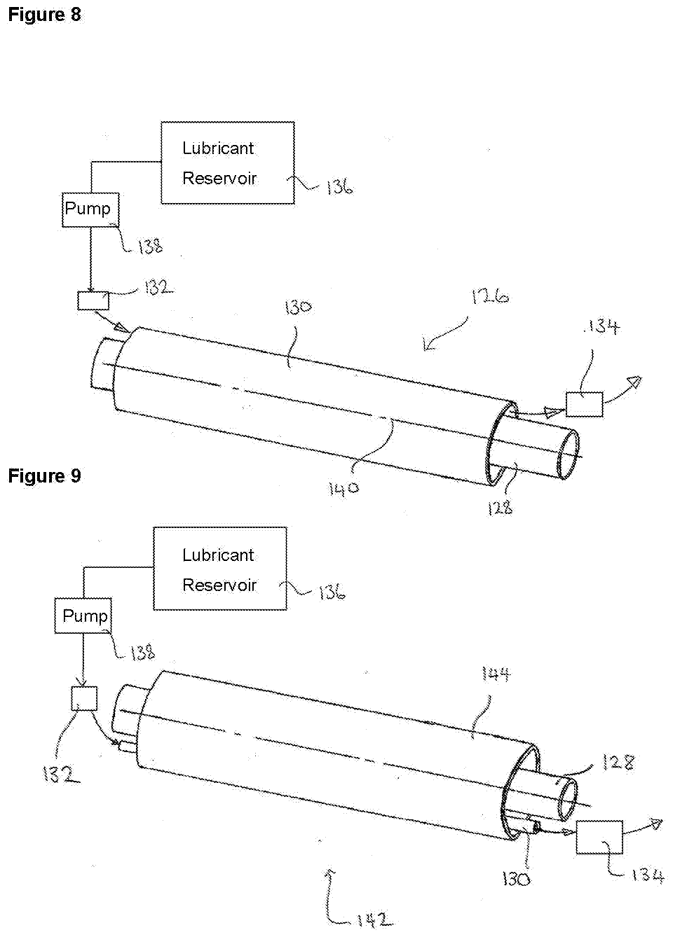

FIG. 8 illustrates a perspective schematic diagram of a shaft 126 for a wind turbine gear box 18 according to various embodiments of the invention. The shaft 126 has a longitudinal axis 140 and includes a first conduit 128, a second conduit 130 and may include a combination of one or more fluid couplings such as a first fluid coupling 132 and a second fluid coupling 134. The shaft 126 may be installed in a wind turbine gear box 18 so that the longitudinal axis 140 is oriented substantially parallel with the longitudinal axis 60 of the gear box 18. In some embodiments, the shaft 126 may be installed in a wind turbine gear box 18 so that the longitudinal axis 140 coincides with the longitudinal axis 60 of the gear box 18 (i.e. the shaft 126 is positioned at the radial centre of the gear box 18). The shaft 126 may extend for a substantial length of the gear box 18 and may extend between the gear 44 and the input shaft 24 for example. The second conduit 130 or the first rotary coupling 132 is arranged to receive lubricant (e.g. oil) from a lubricant reservoir 136 via a pump 138. The second fluid coupling 134, if present, is arranged to provide the lubricant to components of the wind turbine gear box 18.

The first conduit 128 includes a first tube (e.g. a wind turbine gear box pilot tube) which is substantially cylindrical. When installed in a gear box 18, electrical cables (not illustrated in the figure) may be run through the interior of the first tube, and connections between the cables and gear box elements rotating at different speeds can be affected by means of, for example, slip rings located at the ends of the first tube. The second conduit 130 includes a second tube which is also substantially cylindrical. The first tube 128 is positioned within the second tube 130 in a concentric arrangement. In other embodiments, the first tube 128 may be positioned within the second tube 130 in a non-concentric arrangement.

In some embodiments, the shaft, the first conduit 128 and the second conduit 130 are configured to rotate about the longitudinal axis 140. The first fluid coupling 132 is a rotary fluid coupling and is arranged to provide a sealed interface that allows lubricant to be transferred to the rotating second tube 130 from a non-rotating source, or from a source that rotates at a different angular speed to the second tube 130. If present, the second fluid coupling 134 is a rotary fluid coupling and is arranged to provide a sealed interface that allows lubricant to be transferred from the rotating second tube 130 to a non-rotating component of the gear box 18 or to a component of the gear box 18 that rotates at a different angular speed to the second tube 130.

In other embodiments, the shaft, the first conduit 128 and the second conduit 130 are configured to remain stationary about the longitudinal axis 140. The first fluid coupling 132, if present, is arranged to provide a sealed interface that allows lubricant to be transferred to the second tube 130 from a non-rotating source. If present, the second fluid coupling 134 is a rotary fluid coupling and is arranged to provide a sealed interface that allows lubricant to be transferred from the non-rotating second tube 130 to a rotating component of the gear box 18.

In further embodiments, the first conduit 128 and the second conduit 130 rotate at different speeds relative to each other. In one example, the second conduit 130 is configured to remain stationary about the longitudinal axis 140, and the first conduit 128 rotates about the longitudinal axis 140. The first fluid coupling 132, if present, is arranged to provide a sealed interface that allows lubricant to be transferred to the second tube 130 from a non-rotating source. If present, the second fluid coupling 134 is arranged to provide a sealed interface that allows lubricant to be transferred from the non-rotating second tube 130 to a rotating component of the gear box 18. In another example, the second conduit 130 is configured to rotate about the longitudinal axis 140, and the first conduit 128 is configured to remain stationary. The first fluid coupling 132, if present, is arranged to provide a sealed interface that allows lubricant to be transferred to the second tube 130 from a non-rotating source. If present, the second fluid coupling 134 is arranged to provide a sealed interface that allows lubricant to be transferred from the rotating second tube 130 to a non-rotating component of the gear box 18 or to a component of the gear box 18 that rotates at a different angular speed to the second tube 130.

When the gear box 18 is in operation, lubricant such as oil is pumped from the lubricant reservoir 136 to the first coupling 132 by the pump 138. The lubricant is transferred into the second tube 130 at the first coupling 132 and flows in the cavity defined between the exterior of the first tube 128 and the interior of the second tube 130. The lubricant is transferred from the downstream end of the second tube 130 (via the second coupling 134, if present,) and is provided (via channels for example) to components of the wind turbine gear box 18 (the planet carrier 26 for example).

The shaft 126 provides an advantage in that it may allow lubricant to be transferred to substantially all components of the gear box 18 since the shaft 126 may extend for a substantial portion of the axial length of the gear box 18. Furthermore, the first and second rotary fluid couplings 132, 134 enable lubricant to be transferred between static components and the rotating shaft 126 and between the shaft 126 and components that rotate at a different angular velocity to the shaft 126.

FIG. 9 illustrates another embodiment of a shaft 142 according to various embodiments of the invention. The shaft 142 illustrated in FIG. 9 is similar to the shaft 126 illustrated in FIG. 8 and where the features are similar, the same reference numerals are used. The shaft 142 differs from the shaft 126 in that the shaft 142 includes an outer tube 144 in which the first conduit 128 and the second conduit 130 are positioned. In this embodiment, the first conduit 128 is concentric with the outer tube 144 and the second conduit 130 is non-concentric with the outer tube 144. In addition, a plurality of second conduits may be positioned in the outer tube 144, for example, radially with respect to the longitudinal axis. The second conduit may be configured to rotate, or it may be configured to be stationary with respect to non-rotating elements of the gear box.

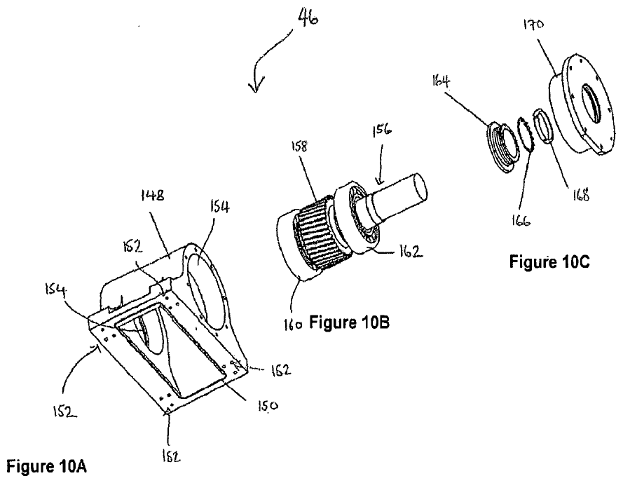

FIGS. 10A, 10B and 10C illustrate an exploded perspective view of a module 46 for a wind turbine gear box 18 according to various embodiments of the invention. As described above with reference to FIG. 2, the module 46 is attachable/detachable to a wind turbine gear box and provides an output for the wind turbine gear box that may be connected to a generator or other auxiliary drive unit.

In more detail and with reference to FIG. 10A, the module 46 includes a housing 148 defining a first aperture 150, a plurality of second apertures 152 and two third apertures 154. The housing 148 also includes a sealing arrangement (e.g. an ‘O’ ring seal) that extends at least partially around the first aperture 150.

With reference to FIG. 10B, the module 46 also includes an output shaft 156 comprising a gear portion 158 (corresponding to the output shaft 50 and the third stage second output gear 48 illustrated in FIG. 2), a first bearing 160 and a second bearing 162. The first bearing 160 is positioned around the output shaft 156 at one side of the gear portion 158 and the second bearing 162 is positioned around the output shaft 156 at the other side of the gear portion 158. The first and second bearings 160, 162 are mountable in the two third apertures 154 and may thereby support the output shaft 156 in the housing 148.

With reference to FIG. 10B, the first bearing 160 and/or the second bearing 162 may be embodied by various bearing types. Each may consist of one bearing with one or more rows of rolling elements or consist of two adjacent bearings with one or more rows of rolling elements. The first bearing 160 and second bearing 162 are not limited to rolling element bearings (e.g. either may also be hydrodynamic type bearings).

With reference to FIG. 10C, the module 46 also includes a seal (e.g. labyrinth seal 164), a locking washer 166, a lock nut 168 and a housing cap 170 (including a labyrinth seal). The seal 164 may be joined to the labyrinth seal of the housing cap 170 and the locking washer 166 and the lock nut 168 may be provided there between. The assembled housing cap 170 may be positioned in one of the third apertures 154 and support the second bearing 162 axially and/or radially.

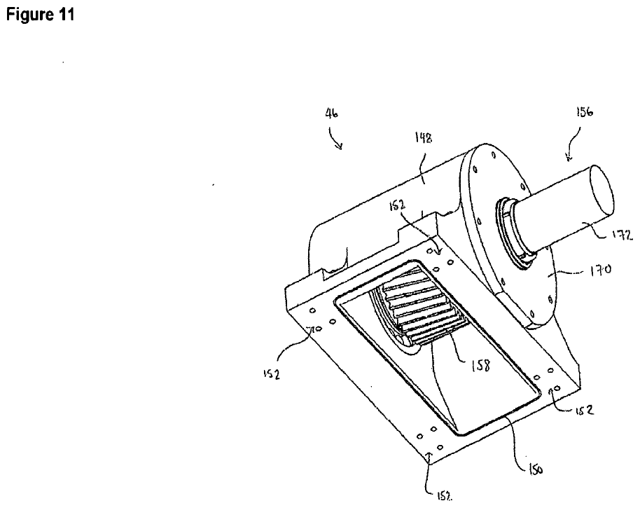

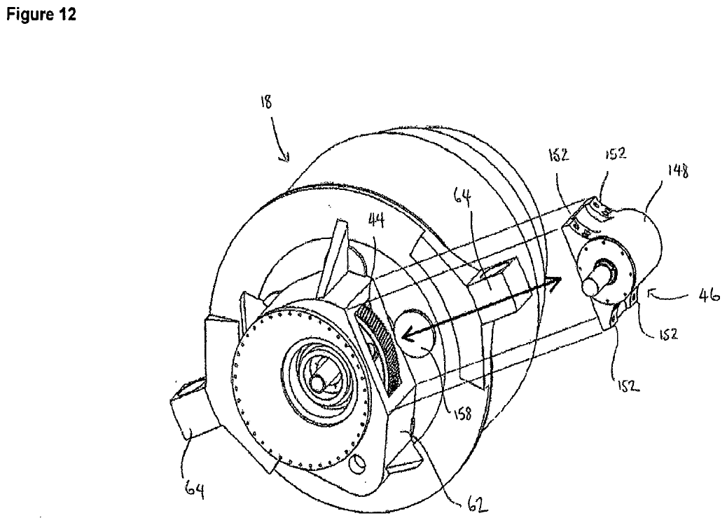

FIG. 11 illustrates a perspective view of the module 46 illustrated in FIGS. 10A, 10B and 10C fully assembled. It should be appreciated from FIG. 11, that the gear portion 158 is positioned within the housing 148 so that it is adjacent the first aperture 150. Furthermore, it should be appreciated that a portion 172 of the output shaft 156 protrudes from the housing cap 170 and may be connected to a wind turbine generator or other auxiliary drive unit.

FIG. 12 illustrates a perspective view of a wind turbine gear box 18 and a module 46 according to various embodiments of the invention. The module 46 may be attached and detached from the non-rotating support component 62 (e.g. a housing of the gear box 18) by a person. As illustrated in FIG. 12, the connection of the module 46 to the gear box 18 results in the third stage second output gear 158 engaging the third stage first output gear 44.

In order to join the module 46 and the gear box 18 together, a person may insert fasteners (e.g. bolts) into the plurality of second apertures 152 (and corresponding apertures on the non-rotating support component 62) and use a hand tool or a power tool on the fasteners to fasten the module 46 and the gear box 18 together. A person may detach the module 46 from the gear box 18 by using a hand tool or a power tool on the fasteners.

It should be appreciated that the module 46 may comprise alternative means for attaching to and detaching from the gear box 18. For example, the module 46 and the gear box 18 may comprise a slot and groove arrangement that may be secured via one or more pins.

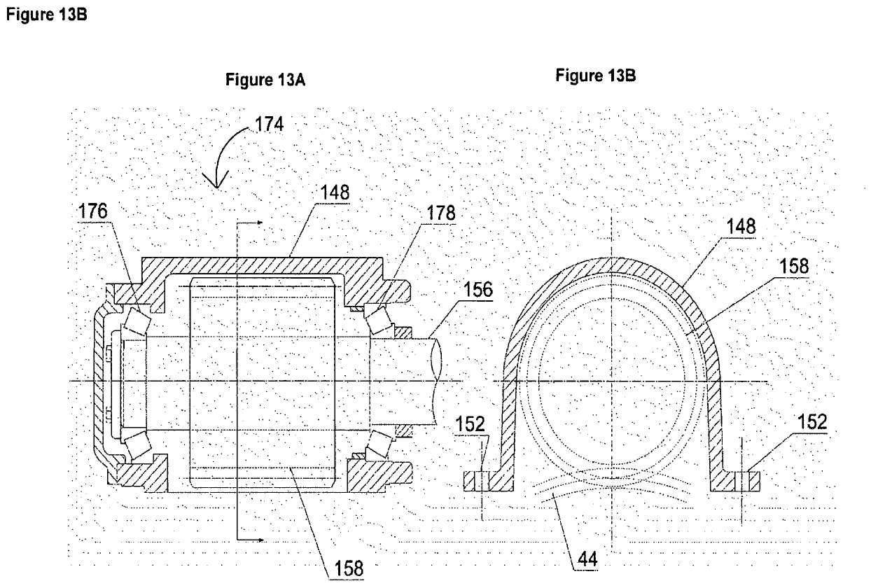

FIG. 13A and 13B illustrate a cross sectional side view and a cross sectional front view respectively of another module 174 according to various embodiments of the invention. The module 174 is similar to the module 46 illustrated in FIGS. 10 to 12 and where the features are similar, the same reference numerals are used. The module 174 differs from the module 46 in that the first and second bearings 176, 178 form a back to back tapered bearing arrangement.

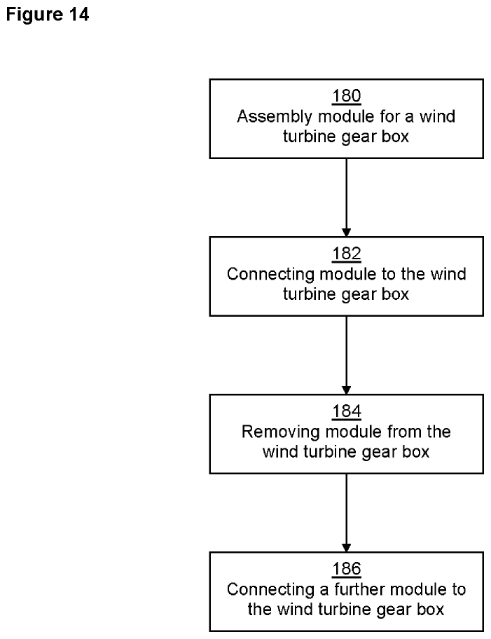

FIG. 14 illustrates a method of assembling, connecting and detaching a module 46, 174 according to various embodiments of the invention. At block 180, the method includes assembling a module 46, 174 in a factory and preload setting the bearings 160, 162, 176, 178. It should be appreciated that the assembly of the module 46, 174 in the factory may be performed remotely from the wind turbine location (i.e. hundreds or even thousands of kilometers away) in which the module 46, 174 will be installed.

At block 182, the method includes connecting the module 46, 174 to the gear box 18. One or more people may insert fasteners through the plurality of second apertures 152 and use hand tools and/or power tools on the fasteners to fasten the module 46, 174 to the gear box 18.

At block 184, the method includes removing the module 46, 174 from the gear box 18. One or more people may use hand tools and/or power tools on the fasteners inserted in the second apertures 152 to remove the fasteners and thereby detach the module 46, 174 from the gear box 18. It may be desirable to remove the module 46, 174 if it is determined that the module 46, 174 is damaged (e.g. one or both of the bearings 160, 162 or 176, 178 are worn) or if a different gear ratio is desired for the gear box 18. A different gear ratio may be desirable, for example, if the wind turbine gear box is to be used in a different region or environment, where the prevailing wind speeds may be different, or the input speed to the generator is different (if the desired frequency of electricity generated is different, for example).

At block 186, the method includes connecting/attaching a further pre-assembled module according to various embodiments of the present invention to the gear box 18. The output shaft of the further module may have a different positional offset (i.e. different radial position) to the module replaced in block 184. The further module may have a gear portion 158 that has the same number of teeth as the gear portion in the module removed in block 184. In this example, the further module provides a direct replacement for the removed (damaged) module. In other embodiments of the invention, the further module may have a gear portion 158 that has a different number of teeth to the gear portion in the module removed in block 184. In these embodiments, the replacement of the output module advantageously changes the gear ratio of the wind turbine gear box 18.

The module 46, 174 may provide several advantages. One such advantage is that the module 46, 174 may be relatively easily attached to, and detached from a wind turbine gear box 18 by one or more people using hand tools and/or power tools. Furthermore, since the module 46, 174 may be fully assembled and configured in a factory, the person installing the module 46, 174 may not have to carry out any difficult and/or time consuming configuration tasks when installing the module 46, 174 in the nacelle 12 of the wind turbine 10. Consequently, where a module becomes damaged, the replacement of that module may be a relatively quick task and may reduce the time that the wind turbine is out of operation.

As mentioned above, embodiments of the present invention provide an advantage in that they enable one or more people to relatively easily change the gear ratio of the gear box 18 by replacing a module having a first number of gear teeth with a further module having a second different number of gear teeth. Furthermore, embodiments of the present invention may enable one or more people to relatively easily change the output shaft positional offset.

The module 174 illustrated in FIGS. 13A and 13B may provide an advantage in that the bearing arrangement 176, 178 may have a relatively low temperature sensitivity. This may be particularly advantageous when the output shaft is rotating at relatively high angular speeds.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described. For example, the wind turbine gear box 18 may include any one or more of (in any combination): the gear box arrangement illustrated in FIG. 3, the gearing arrangements illustrated in FIGS. 5 to 7, the shafts illustrated in FIGS. 8 & 9 and the modules illustrated in FIGS. 10 to 13.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A wind turbine gear box arrangement comprising:
an input shaft arranged to rotate about a longitudinal axis;
a first stage and a second stage;
a non-rotating support component arranged to support the input shaft, wherein a body of the non-rotating support component has a generally cylindrical shape and includes a first portion and a second portion, in which the first portion extends radially outwards from the body of the non-rotating support component and is torsionally connected to a ground point and the second portion has a smaller diameter than the input shaft and is positioned at least partially within the input shaft.;
one or more bearings located in a single region along the longitudinal axis and arranged to provide support between the input shaft and the non-rotating support component, wherein the one or more bearings are arranged to at least partially restrict non-rotational movement between the input shaft and the non-rotating support component, wherein a portion along said longitudinal axis between said input shaft and said non-rotating support component is bearingless outside said single region.

2. The gear box arrangement according to claim 1, wherein:
said planet carrier is located substantially within said input shaft.

3. The gear box arrangement according to claim 1, wherein:
said one or more bearings are arranged to restrict relative radial movement between said input shaft and said non-rotating support component.

4. The gear box arrangement according to claim 1, wherein:
said one or more bearings are arranged to restrict relative axial movement between said input shaft and said non-rotating component.

5. The gear box arrangement according to claim 1, wherein:
said one or more bearings are arranged to restrict relative tilt movement between said input shaft and said non-rotating component.

6. The gear box arrangement according to claim 1, wherein:
said one or more bearings comprise a double row tapered roller bearing.

7. The gear box arrangement according to claim 1, further comprising:
an outer surface and said input shaft is arranged to define said outer surface.

8. The gear box arrangement according to claim 1, wherein the gear box arrangement is adapted for use in a wind turbine.

9. A wind turbine incorporating a gear box arrangement as claimed in claim 1.
